(19) United States
(12) Patent Application Publication
(10) Pub. No.: US 2002/0061949 A1
(43) Pub. Date: May 23, 2002

(54) Flame-retardant composition

(76) Inventors: Yongxia Wang, Piscataway, NJ (US); James W. Nowicki, Hopewell, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 09/965,921

(22) Filed: Sep. 28, 2001

Related U.S. Application Data
(60) Provisional application No. 60/236,980, filed on Sep. 29, 2000.

(51) Int. Cl. C08K 5/09

(52) U.S. Cl. 524/321

(57) ABSTRACT

Flame retardant polyurethane compositions comprising ethylenebistetrabromophthalimide and/or tris(2,3-dibromopropyl)isocyanurate as fire retardant component.

This application claims benefit to the earlier filing date of provisional application No. 60/236,980, filed Sep. 29, 2000.

### FIELD OF THE INVENTION

The invention relates to polyurethane compositions, in particular polyurethane compositions having improved fire retardant properties. The invention also relates to articles comprising such compositions.

### BACKGROUND OF THE INVENTION

Polyurethane compositions have been used in may applications such as polyurethane foams, coatings, sealants and adhesives. In recent years there has been a growing awareness of the need for greater resistance to combustion of seating, trim, building materials, and the like, particularly in applications where a number of people may be at risk at one time, such as rail carriages, aircraft, buses, boats, public buildings and hospitals where large amounts of combustible materials are present.

While polyurethane compositions are extensively used in a number of industrial applications, the flame retardant features need improvement. There continues to be a need in the art for polyurethane compositions with designed physical, chemical and mechanical properties, especially imparting excellent flame retardancy.

### SUMMARY OF THE INVENTION

The present invention provides flame-retardant compositions. Flame retardancy is achieved by utilizing ethylenebistetrabromophthalimide and/or tris(2,3-dibromopropyl)isocyanurate as a flame retardant component. Addition of these components as fire retardant(s) to polyurethane compositions increases the fire resistance of such compositions and products manufactured therewith.

One embodiment of the invention is directed to a method of imparting flame retardant properties to a polyurethane composition comprising adding an effective amount of ethylenebistetrabromophthalimide and/or tris(2,3-dibromo-propyl)isocyanurate as a fire retardant.

Other embodiments of the invention are directed to flame-retardant polyurethane foams, coatings, rubbers, sealants and adhesives, including two-part polyurethane adhesives, liquid polyurethane adhesives and reactive hot melt polyurethane adhesives.

One particularly preferred aspect of the invention provides a polyurethane composition comprising an isocyanate, a polyol and, as a fire retardant component, ethylenebistetrabromophthalimide and/or tris(2,3-dibromopropyl)-isocyanurate. The composition may further comprise a chlorinated paraffin and/or an aryl phosphate ester, as a further flame retardant component.

Still other aspects of the invention provides articles of manufacture prepared using the flame retardant polyurethane compositions. Such articles find use in a large number of industries and applications, including construction, automotive, textile and clothing industries.

### DETAILED DESCRIPTION OF THE INVENTION

The disclosures of all references cited herein are incorporated in their entireties by reference.

The invention provides a method of imparting flame retardant properties to a polyurethane composition comprising adding an effective amount of ethylenebistetrabromophthalimide and/or tris(2,3-dibromopropyl)isocyanurate as a fire retardant. The flame retardants of the invention may be used to increase the flame resistance of polyurethane compositions including, without limitation, flame-retardant polyurethane foams and flame-retardant polyurethane adhesives including two-part polyurethane adhesives, liquid polyurethane adhesives and reactive polyurethane hot melt adhesives.

By “effective amount” of flame retardant, as used herein, means an amount sufficient to impart the desired flame resistant properties. Such an amount can be readily determined by a skilled practitioner.

The fire retardant component of the invention is advantageously added during the conventional manufacturing process of the polyurethane compositions to provide polyurethane compositions having very high levels of flame retardancy.

While the invention will hereinafter be described in terms of flame retardant reactive hot melt polyurethane adhesives, it will be understood that the invention is not to be so limited. The invention provides for the preparation of a variety of polyurethane compositions having flame retardant properties. For example, the foams of the invention can be molded, cut to shape or laid down on a backing material, so affording protection against fire in depth. A preferred use is as cushion materials for automobiles, beds, sofas, seat cushioning, particularly in public transport vehicles such as buses and airplanes, and for use as an insulation material (e.g., for exterior and interior walls and roofing).

Reactive hot melt adhesives, also known as “polyurethane hot melt adhesives,” are comprised of isocyanate-terminated polyurethane polymers, often referred to as “prepolymers,” that react with surface or ambient moisture in order to chain-extend and form a second polyurethane polymer.

Unlike conventional hot melt adhesives, which can be heated to a liquid state and cooled to a solid state repeatedly, a reactive hot melt undergoes an irreversible chemical reaction to a solid “cured” form once dispensed in the presence of ambient moisture. Reactive hot melts are therefore useful in the manufacture of articles which are or may potentially be exposed to high temperatures. Articles for which reactive hot melts are particularly useful as adhesives include architectural components on building exteriors and interiors and components of recreational vehicles, such as cars and vans.

The reactive hot melt adhesives of the invention use ethylenebistetrabromophthalimide and/or tris(2,3-dibromopropyl)isocyanurate as a prime flame retardant component. The ethylenebistetrabromophthalimide and/or tris(2,3-dibromopropyl)isocyanurate may be used with or without other flame retardants. The flame retardant polyurethane-based reactive hot melt adhesives of the invention give excellent flame retardancy while maintaining the targeted properties of the base polymer, such as good green strength, controlled setting speed and good thermal stability at elevated temperatures.

Reactive polyurethane hot melt adhesives of the invention comprise an isocyanate, a polyol and ethylenebistetrabromophthalimide and/or tris(2,3-dibromopropyl)isocyanurate. The composition may further comprise a chlorinated paraffin and/or an aryl phosphate ester as a further flame retardant component.

The fire retardant additive comprises at least one of ethylenebistetrabromophthalimide or tris(2,3-dibromopropyl)isocyanurate in effective amount, generally from about 1 to about 50 parts by weight, more preferably 5 to about 30 parts by weight of the total polyurethane adhesive composition.

The ethylenebistetrabromophthalimide component has the potential to form hydrogen bonding with the polyurethane backbone, which compatibilized the flame retardant with the polymer matrix. The brominated isocyanurate component may also form hydrogen bonding with the polymer backbone, generating a homogeneous flame retardant adhesive.

In addition to ethylenebistetrabromophthalimide and/or tris(2,3-dibromopropyl)isocyanurate, the flame retardant composition may further comprise up to about 10 parts by weight of a chlorinated paraffin and up to about 10 parts by weight of an aryl phosphate ester, as further flame retardant component. The optional chlorinated paraffin imparts flame retardancy as well as performing as a viscosity modifier. The aryl phosphate ester further imparts improved adhesion to the substrates.

The term “chlorinated paraffin” as used herein, includes a single chlorinated paraffin, or mixtures thereof. The chlorinated paraffins usually have a chlorine content of at least 50%, although if a mixture of chlorinated paraffins is used, those with less chlorine may be included. The chlorinated paraffins may be either liquid or solid, for example, Cereclor 70 L or Cereclor 70 (ICI). These chlorinated paraffins are generally represented by the following emperical formula CₙH_{[(2n+}_{2)-y]}Cl_{y} where n ranges from about 10 to about 25 and y ranges from aboutom about 5 to 25, and preferably n is about 12 and y is about 11.

Aryl phosphates which may be used include triarylphosphate may include triphenylphosphate, tri(p-methylphenyl)phosphate, diisopropylmono-phenylphosphate, monoisopropyldiphenylphosphate, and the like. The aryl phosphates may be present in an amount up to about 10 parts by weight, preferably from about 2 to about 8 parts by weight.

In addition to the chlorinated paraffin and aryl phosphate ester components, as further flame retardant component, other fire retardant additives known in the art for imparting flame resistance to polyurethane compositions may be added. Such compounds include inorganic compounds such as a boron compound, aluminum hydroxide, antimony trioxide and the like, and other halogen compounds including halogen-containing phosphate compounds such as tris(chloroethyl)phosphate, tris(2,3-dichloropropyl)-phosphate, and the like. These and other flame retarding compositions are described in U.S. Pat. Nos. 3,773,695 4,266,042, 4,585,806, 4,587,273 and 4,849,467, and European Patent No. 0 587 942.

The urethane prepolymers are those conventionally used in the production of polyurethane hot melt adhesive compositions. Any suitable compound which contains two or more isocyanate groups may be used for preparing the urethane prepolymers. Typically from about 5 to about 75 parts by weight of an isocyanate is used.

Organic polyisocyanate which may be used to practice the invention include alkylene diisocyanates, cycloalkylene diisocyanates, aromatic diisocyanates and aliphatic-aromatic diisocyanates. Spcific examples of suitable isocyanate-containing compounds include, but are not limited to, ethylene diisocyanate, ethylidene diisocyanate, propylene diisocyanate, butylene diisocyanate, trimethylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triiso-cyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well-known in the art. Preferred isocyanate-containing compounds are methylenebisphenyidiisocyanate (MDI), isophoronediisocyanate (IPDI) and toluene diisocyanate (TDI).

Most commonly, the prepolymer is prepared by the condensation polymerization of a polyisocyanate with a polyol, most preferably the polymerization of a diisocyanate with a diol. The polyols used include polyhydroxy ethers (substituted or unsubstituted polyalkylene ether glycols or polyhydroxy polyalkylene ethers), polyhydroxy polyesters, the ethylene or propylene oxide adducts of polyols and the monosubstituted esters of glycerol, as well as mixtures thereof. The polyol is typically used in an amount of between about 1 to about 70 parts by weight.

Examples of polyether polyols include a linear and/or branched polyether having plural numbers of ether bondings and at least two hydroxyl groups, and contain substantially no functional group other than the hydroxyl groups. Examples of the polyether polyol may include polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct at least one compound selected from the group consisting of ethylene glycol, propylene glycol, diethylene glycol, dipropylene glycol, triethylene glycol, 2-ethylhexanediol-1,3, glycerin, 1,2,6-hexane triol, trimethylol propane, trimethylol ethane, tris(hydroxyphenyl)propane, triethanolamine, triisopropanolamine, ethylenediamine and ethanolamine; with at least one compound selected from the group consisting of ethylene oxide, propylene oxide and butylene oxide.

A number of suitable polyols available commercially. By way of example only, there is mentioned CP4701 (Dow Chemicals), Niax 11-34 (Union Carbide Corp), Desmophen 3900 (Bayer), Propylan M12 (Lankro Chemicals), Highflex 303 (Daiichi Kogyo Seiyaku K. K.) and Daltocel T 32-75 (ICI). “Polymer polyols” are also suitable, i.e. graft polyols containing a proportion of a vinyl monomer, polymerised in situ, e.g., Niax 34-28.

Polyester polyols are formed from the condensation of one or more polyhydric alcohols having from 2 to 15 carbon atoms with one or more polycarboxylic acids having from 2 to 14 carbon atoms. Examples of suitable polyhydric alcohols include ethylene glycol, propylene glycol such as 1,2-propylene glycol and 1,3-propylene glycol, glycerol, pentaerythritol, trimethylolpropane, 1,4,6-octanetriol, butanediol, pentanediol, hexanediol, dodecanediol, octanediol, chloropentanediol, glycerol monallyl ether, glycerol monoethyl ether, diethylene glycol, 2-ethylhexanediol-1,4, cyclohexanediol-1,4, 1,2,6-hexanetriol, 1,3,5-hexanetriol, 1,3-bis-(2-hydroxyethoxy)propane and the like. Examples of polycarboxylic acids include phthalic acid, isophthalic acid, terephthalic acid, tetrachlorophthalic acid, maleic acid, dodecylmaleic acid, octadecenylmaleic acid, fumaric acid, aconitic acid, trimellitic acid, tricarballylic acid, 3,3′-thiodipropionic acid, succinic acid, adipic acid, malonic acid, glutaric acid, pimelic acid, sebacic acid, cyclohexane-1,2-dicarboxylic acid, 1,4-cyclohexadiene-1,2-dicarboxylic acid, 3-methyl-3,5-cyclohexadiene-1,2-dicarboxylic acid and the corresponding acid anhydrides, acid chlorides and acid esters such as phthalic anhydride, phthaloyl chloride and the dimethyl ester of phthalic acid. Preferred polycarboxylic acids are the aliphatic and cycloaliphatic dicarboxylic acids containing no more than 14 carbon atoms and the aromatic dicarboxylic acids containing no more than 14 atoms.

In addition, the urethane prepolymers may be prepared by the reaction of a polyisocyanate with a polyamino or a polymercapto-containing compound such as diamino polypropylene glycol or diamino polyethylene glycol or polythioethers such as the condensation products of thiodiglycol either alone or in combination with other glycols such as ethylene glycol, 1,2-propylene glycol or with other polyhydroxy compounds disclosed above. In accordance with one embodiment of the invention, the hydroxyl containing acrylic polymer may function as the polyol component, in which case, no additional polyol need be added to the reaction.

Further, small amounts of low molecular weight dihydroxy, diamino, or amino hydroxy compounds may be used such as saturated and unsaturated glycols, e.g., ethylene glycol or condensates thereof such as diethylene glycol, triethylene glycol, and the like; ethylene diamine, hexamethylene diamine and the like; ethanolamine, propanolamine, N-methyidiethanolamine and the like.

It has been found that the performance of reactive hot melt adhesives for most applications may be substantially improved by the incorporation of acrylic polymers into conventional polyurethane adhesives, as describe in U.S. Pat. No. 5,021,507 and U.S. Pat. No. 5,866,656. In a preferred embodiment of the invention, the urethane is modified by the incorporation of acrylic resins, in particular reactive hydroxy-containing and non-reactive acrylic copolymers. Preferably between about 0 to about 40% by weight of the hydroxylated and or non-hydroxylated acrylic polymer is present in the in the adhesive composition.

Virtually any ethylenically unsaturated monomer containing hydroxyl functionality greater than one may be utilized in the compositions of the present invention. Most commonly employed are hydroxyl substituted C1 to C12 esters of acrylic and methacrylic acids including, but not limited to hydroxyl substituted methyl acrylate, ethyl acrylate, n-butyl acrylate, 2-ethylhexyl acrylate, isobutyl acrylate, n-propyl or iso-propyl acrylate or the corresponding methacrylates. Mixtures of compatible (meth)acrylate monomers may also be used. Additional monomers that may be used include the hydroxyl substituted vinyl esters (vinyl acetate and vinyl propionate), vinyl ethers, fumarates, maleates, styrene, acrylonitrile, etc. as well as comonomers thereof.

If used as monomers, these monomers are blended with other copolymerizable comonomers as formulated so as to have a wide range of Tg values, as between about −48° C. and 105° C., preferably 15° C. to 85° C. Suitable comonomers include the C1 to C12 esters of acrylic and methacrylic acids including, but not limited to methyl acrylate, ethyl acrylate, n-butyl acrylate, isobutyl acrylate, 2-ethylhexyl acrylate, n-propyl or iso-propyl acrylate or the corresponding methacrylates. Mixtures of compatible (meth)acrylate monomers may also be used. Additional monomers that may be used include the vinyl esters (vinyl acetate and vinyl propionate), vinyl ethers, fumarates, maleates, styrene, acrylonitrile, ethylene, etc. as well as comonomers thereof.

The hydroxyl containing monomers may be the same or different from the monomers used in the remainder of the acrylic polymerization. The particular monomers selected will depend, in large part, upon the end use for which the adhesives are intended. Thus, adhesives to be used in pressure sensitive applications or in applications wherein adhesion to metal is required will be selected to obtain a lower Tg polymer than may be desired in non-pressure sensitive applications or those involving more easily bonded substrates.

When the adhesive is to be prepared utilizing monomeric materials, the respective monomers may be added to the polyols and polymerized therein prior to formation of the prepolymer or may be added to the already formed prepolymer and the acrylic polymerization subsequently performed. In the case of polyamino or polymercapto containing prepolymers, in-situ vinylic polymerization must be performed only in the pre-formed prepolymer.

The hydroxyl containing ethylenically unsaturated monomer is polymerized using conventional free radical polymerization procedures to a relatively low molecular weight. For purposes of clarification herein, by “low molecular weight” we mean number average molecular weights in the range of approximately 4,000 to 15,000, preferably to 12,000. Molecular weight distribution is characterized by Gel Permeation Chromatography using a PL Gel,Mixed 10 micron column, a Shimadzu Model RID 6A Detector with a tetrahydrofuran carrier solvent at a flow rate of 1 milliliter per minute. The low molecular weight is obtained by careful monitoring and controlling the reaction conditions and, generally, by carrying out the reaction in the presence of a chain transfer agent such as dodecyl mercaptan. Subsequent to the polymerization of the ethylenically unsaturated monomer(s), the polyisocyanate and any additional ingredients required for the urethane prepolymer forming reaction are added and that reaction is carried out using conventional condensation polymerization procedures. In this manner, the resultant isocyanate terminated urethane prepolymer forms the reactive curing hot melt adhesive described above which contains about 10 to 70% of the urethane prepolymer and 30 to 90% of the low molecular weight hydroxyl containing polymer.

It is also possible to polymerize the low molecular weight polymer in the presence of the already formed isocyanate terminated urethane prepolymer. This method has the drawback of subjecting the prepolymer to unnecessary heating during the acrylic polymerization, heating that might result in branching, viscosity increase, depletion of needed isocyanate groups and possible gellation. Although these disadvantages are subject to control, more stringent control of conditions are required as compared to polymerization in the non-isocyanate functional urethane components. When the reaction is run in the polyol or other non-isocyanate containing component, there is also the advantage of lower reaction viscosities and reduced exposure to isocyanate vapors because of the lesser amount of heating required.

Optionally, the hydroxyl containing functionality may be introduced into the adhesive in the form of pre-polymerized low molecular weight hydroxyl containing polymers. In the latter case, typical polymers include hydroxyl substituted butyl acrylate, hydroxylated butyl acrylate/methyl methacrylate copolymers, hydroxylated ethyl acrylate/methyl methacrylate copolymers, and the like, the polymers having a number average molecular weight of 4,000 to 12,000 and a hydroxyl number of 5 to 15. If used in the form of low molecular weight polymers, the polymers may be blended with the polyol prior to reaction thereof with the isocyanate or they may be added directly to the isocyanate terminated prepolymer.

Preferred adhesives of the invention typically comprise from about 5 to about 50 parts by weight of an isocyante, from about 1 to about 70 parts by weight of a polyol, from about 0 to about 40 parts by weight of an acrylic copolymer and, as a fire retardant component, from about 1 to about 50 parts by weight of ethylenebistetrabromophthalimide and/or tris(2,3-dibromopropyl)isocyanurate. The polyol may be a polyester polyol, a polyether polyol or a combination thereof. The composition may further comprise from about 0 to about 10 parts by weight of a chlorinated paraffin and from about 0 to about 10 parts by weight of an aryl phosphate ester, as further flame retardant components.

While the adhesives may be used directly as described above, if desired the adhesives of the present invention may also be formulated with conventional additives which are compatible with the composition. Such additives include plasticizers, compatible tackifiers, catalysts, fillers, anti-oxidants, pigments, adhesion promoters, stabilizers and the like. Conventional additives which are compatible with a composition according to this invention may simply be determined by combining a potential additive with the composition and determining if they are compatible. An additive is compatible if it is homogenous within the product.

This invention also provides a method for bonding articles together which comprises applying the subject reactive hot melt adhesive composition in a liquid melt form to a first article, bringing a second article in contact with the composition applied to the first article, and subjecting the applied composition to conditions which will allow the composition to cool and cure to a composition having an irreversible solid form, said conditions comprising moisture. The composition is typically distributed and stored in its solid form. The composition should be stored in the absence of moisture. When the composition is ready for use, the solid is heated and melted prior to application. Thus, this invention includes reactive polyurethane hot melt adhesive compositions in both its solid form, as it is typically to be stored and distributed, and its liquid form, after it has been melted, just prior to its application.

Methods for applying the subject liquid melt composition are known in the art and include, but are not limited to, roll coating, spraying, and extrusion.

After application, to adhere articles together, the reactive hot melt adhesive composition is subjected to conditions which will allow it to solidify and cure to a composition which has an irreversible solid form. Solidification (setting) occurs when the liquid melt is subjected to room temperature. Curing, i.e. chain extending, to a composition which has a irreversible solid form, takes place in the presence of ambient moisture and is usually complete between about four hours and about seventy-two hours, in general after approximately twenty-four hours.

As used herein, “irreversible solid form” means a solid form comprising polyurethane polymers extended from the aforementioned polyurethane prepolymers. The composition having the irreversible solid form typically can withstand temperatures of up to 150° C. Using ethylenebistetrabromophthalimide as a flame retardant, the thermal stability of the irreversible solid form was improved as evidenced by thermogravimetric analysis.

The invention also encompasses compositions which result from curing the subject composition of polyurethane prepolymers.

The reactive hot melt adhesive composition of the invention is useful for bonding articles composed of a wide variety of substrates (materials), including, but not limited to wood, metal, glass and textiles. The subject compositions are particularly useful for bonding articles, such as metal entry doors, in particular fire resistant entrance doors, architectural panels, components on the exteriors of vehicles, which may be subjected to weather such as heat or rain, footwear, and textile (e.g., carpet, clothing) bonding applications.

The invention also includes articles which have been bound using the subject hot melt adhesive composition. The invention encompasses any article which comprises the subject hot melt adhesive composition and any article which comprises a composition which results from curing the subject hot melt adhesive composition.

The invention encompasses, for example, metal, e.g., steel, entry doors manufactured with the reactive hot melt adhesive of the invention. The doors may advantageously be prepared by applying the flame-resistant reactive hot melt adhesive in its melted form to a core, applying the door members, i.e., front and back panels, upper and lower cross frame door members and upright end frame members, and allowing the adhesive to cure. The core material may be made of, e.g., expanded polystyrene foam, a honeycomb or reticulated structure, and the like. Typically, the honeycomb or reticulated structure, when used as the core material, is defined by a plurality of parallel strips of sheet material, each strip being formed into a sinous path and bonded to immediately adjacent strips at its outwardly bowed extremities, and is formed of paper, typically Kraft paper. The paper can be untreated or impregnated with a suitable resin for increased stiffness. The doors of the invention are strong and rigid and durable under climatic extremes which include subfreezing temperatures and tropical heat and humidity. Most importantly, they are flame resistant. Such doors are particularly useful in commercial applications where the lives of a large number of people may be at risk at one time, such as doors in apartments and college dormitories.

The invention will be described further in the following examples, which are included for purposes of illustration and are not intended, in any way, to be limiting of the scope of the invention.

### EXAMPLES

### Example I

An isocyanate-terminated prepolymer was prepared from the following charge:

| | | Parts |
|---|---|---|
| | | (by weight) |
| (A) | Poly(hexamethylene adipate) glycol (3500 Mw) | 32.2 |
| | Polypropylene glycol (775 Mw) | 21.7 |
| | MMA-BMA copolymer (30,000 Mw) | 17.4 |
| | Ethylenebistetrabromophthalimide | 13.0 |
| | Degassing aid (modaflow) | 0.4 |
| (B) | Methylene bisphenyl diisocyanate (MDI) | 14.8 |
| (C) | Silane A-189 | 0.4 |

MMA - methyl methacrylate:
BMA - butyl methacrylate

The components in section A were added to a vessel and heated to 120° C., until the polymer was dissolved. Vacuum and agitation were then applied to the system for certain amount of time until the moisture level was below 0.08% by Karl Fisher measurement. At that point, MDI was added, and the reaction was allowed to continue for 2 hours at 120° C. Then the silane was added. The resulting product had a viscosity of 19100 cps at 250° F. using a Brookfield Model DV-II+ Viscometer, a % NCO of 1.6, and stability of 12.5% viscosity rise per hour at 250° F.

A 5-mil thickness film of this product was drawn on a metal plate and allowed to be moisture-cured for one week. A horizontal burning test was conducted using a propane torch with the flame applied to the uncoated side of the metal for 2 minutes. This product did not burn during the test span in contrast to the flame-retardant free counterpart that burned in the middle of the test.

### Example II

An isocyanate-terminated prepolymer was prepared using the following formula:

| | | Parts |
|---|---|---|
| | | (by weight) |
| (A) | Poly(hexamethylene adipate) glycol (3500 Mw) | 29.6 |
| | Polypropylene glycol (775 Mw) | 20.0 |
| | MMA-BMA copolymer (30,000 Mw) | 16.0 |
| | Ethylenebistetrabromophthalimide | 17.3 |
| | Degassing aid (modaflow) | 0.3 |
| (B) | Chlorinated paraffin (Toyoparax 150) | 2.7 |
| (C) | Methylene bisphenyl diisocyanate (MDI) | 13.6 |
| (D) | Silane A-189 | 0.4 |

The components in section A were added to a vessel and heated to 120° C., until the polymer was dissolved. At that point, vacuum and agitation were applied to the system for certain amount of time until the moisture level was below 0.08% by Karl Fisher measurement. At that point, section B in the formula was charged in and the system was further mixed for 20 minutes. At that point, section C in the formula was added, and the reaction was allowed to continue for 2.5 hours at 120° C. Then the silane was added. After this step, the product was poured hot from the vessel.

Characterization of this product yields a viscosity of 15810 cps at 250° F. using a Brookfield Model DV-II+ Viscometer, a % NCO of 1.5, and stability of 13.5% viscosity rise per hour at 250° F.

The product was then coated on a metal plate and allowed to be moisture-cured for one week. The flame test was carried out by a propane torch with the plate placed vertically and the flame applied to the uncoated side of the metal for 60 seconds. Unlike the adhesives containing no flame-retardant, which melted and flowed quickly from the metal as well as giving out huge amount of smoke, this product showed much slower spreading rate and charred during the test and smoked less.

### Example III

An isocyanate-terminated prepolymer was prepared from the following charge:

| | | Parts |
|---|---|---|
| | | (by weight) |
| (A) | Poly(hexamethylene adipate) glycol (3500 Mw) | 29.1 |
| | Polypropylene glycol (775 Mw) | 19.7 |
| | MMA-BMA copolymer (30,000 Mw) | 15.8 |
| | Degassing aid (modaflow) | 0.3 |
| (B) | Methylene bisphenyl diisocyanate (MDI) | 13.4 |
| (C) | Tris(2,3-dibromopropyl) isocyanurate | 19.3 |
| | Chlorinated paraffin | 2.0 |
| (D) | Silane A-189 | 0.4 |

The polymerization procedure was similar to that of Example I except that those components in section C were added after holding the reaction for 2 hours. Then the system was mixed for half an hour before the silane was added. The resulting product had a viscosity of 8950 cps at 250° F. using a Brookfield Model DV-II+ Viscometer, a % NCO of 1.4, and stability of 11.7% viscosity rise per hour at 250° F. A flame-test same as that of Example II was conducted. This product showed similar flame-retarding features as the material from Example II.

### Example IV

The flame-retarding prepolymer was prepared from the following formula:

| | | Parts |
|---|---|---|
| | | (by weight) |
| (A) | Poly(hexamethylene adipate) glycol (3500 Mw) | 29.6 |
| | Polypropylene glycol (775 Mw) | 20.0 |
| | MMA-BMA copolymer (30,000 Mw) | 16.0 |
| | Ethylenebistetrabromophthalimide | 11.6 |
| | Degassing aid (modaflow) | 0.4 |
| (B) | Methylene bisphenyl diisocyanate (MDI) | 13.6 |
| (C) | Chlorinated paraffin | 2.7 |
| | Triphenyl phosphate | 5.7 |
| (D) | Silane A-189 | 0.4 |

The polymerization procedure was similar to Example III. The resulting product had a viscosity of 8200 cps at 250° F. using a Brookfield Model DV-II+ Viscometer, a % NCO of 1.4, and stability of 12.8% viscosity rise per hour at 250° F. This product showed similar flame-retarding features as those from Examples II and III.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A method of imparting flame retardant properties to a polyurethane composition comprising adding an effective amount of ethylenebistetrabromophthalimide and/or tris(2,3-dibromopropyl)isocyanurate as a fire retardant during manufacture of the polyurethane composition.

2. The method of claim 1 wherein the polyurethane composition is a polyurethane foam, polyurethane rubber, polyurethane coating, polyurethane sealant or polyurethane adhesive.

3. The method of claim 2 wherein the polyurethane adhesive is a reactive hot melt adhesive.

4. A polyurethane adhesive comprising an isocyanate, a polyol and a fire retardant selected from the group consisting of ethylenebistetrabromophthalimide, tris(2,3-dibromopropyl)isocyanurate and mixtures thereof.

5. The adhesive of claim 4 wherein the isocyanate is a diisocyanate or a polyisocyanate.

6. The adhesive of claim 5 wherein the fire retardant further comprises a chlorinated paraffin, an aryl phosphate ester and/or antimony trioxide.

8. The adhesive of claim 4 wherein the polyol is a polyether polyol, a polyester polyol or a mixture thereof.

8. The adhesive of claim 7 further comprising an acrylic copolymer.

9. The adhesive composition of claim 8 prepared by reacting from about 5 to about 50 parts by weight of an isocyanate, from about 1 to about 70 parts by weight of a polyol, about 0 to about 40 parts by weight of an acrylic resin and from about 1 to about 50 parts by weight of ethylenebistetrabromophthalimide and/or tris(2,3-dibromopropyl)isocyanurate.

10. The composition of claim 9 further comprising up to about 10 parts by weight of a chlorinated paraffin and/or up to about 10 parts by weight of an aryl phosphate ester, as further a flame retardant component.

11. A method for bonding articles together which comprises applying a reactive hot melt adhesive composition according to claim 1 in a liquid form to a first article, bringing a second article in contact with the composition applied to the first article, and subjecting the applied composition to conditions which will allow the composition to cool and cure to a composition having an irreversible solid form, said conditions comprising moisture.

12. An article of manufacture comprising the adhesive of claim 4.

13. The article of claim 12 which is an entry door.
